(19) United States
(12) Patent Application Publication
(10) Pub. No.: US 2012/0138662 A1
(43) Pub. Date: Jun. 7, 2012

(54) WIRE BONDING METHOD

(75) Inventor: Takayoshi MATSUMURA, Kawasaki (JP)

(73) Assignee: FUJITSU LIMITED, Kawasaki-shi (JP)

(21) Appl. No.: 13/370,047

(22) Filed: Feb. 9, 2012

Related U.S. Application Data
(62) Division of application No. 12/336,384, filed on Dec. 16, 2008.

(30) Foreign Application Priority Data
Dec. 17, 2007 (JP) 2007-324214

(51) Int. Cl. B23K 1/06; B23K 3/00

(52) U.S. Cl. 228/1.1

(57) ABSTRACT

According to an aspect of an embodiment, a wire bonding method includes vibrating a capillary of a bonding head, the capillary having a heater attached thereto at a position corresponding to a node of vibration of the capillary generated by the vibration heating the capillary with the heater and performing a wire bonding operation while heating the capillary with the heater.

### CROSS-REFERENCE TO RELATED APPLICATIONS

This application is a divisional of application Ser. No. 12/336,384, filed Dec. 16, 2008, which claims the benefit of priority from Japanese Patent Application No. 2007-324214 filed on Dec. 17, 2007, which is herein incorporated by reference in its entirety.

### BACKGROUND

1. Field

Embodiments of the present invention relate to a wire bonding method and a wire bonding apparatus used for, for example, electrically connecting a semiconductor chip to a wiring board.

2. Description of Related Art

A wire bonding method is commonly used for, for example, electrically connecting a semiconductor chip to a wiring board. The “related” operations, methods and apparatuses described in this section will hereafter be referred to as “conventional.”

FIG. 6 illustrates a conventional operation of wire-bonding a semiconductor chip 20 to a wiring board 22 with a bonding head 10. The bonding head 10 performs the wire bonding operation by using ultrasonic vibration. The bonding head 10 includes a transducer 12, an ultrasonic generator 14 attached to a base portion of the transducer 12, and a capillary 16 attached to an end portion of the transducer 12. The capillary 16 has a thin cylindrical shape, and a bonding wire is supplied through the capillary 16 from the end attached to the bonding head 10 to a tip end for contacting the semiconductor chip 20.

A single cycle of the wire bonding operation includes bonding the bonding wire to an electrode on the semiconductor chip 20, bonding the bonding wire to a pad on the wiring board 22, and cutting the bonding wire. By repeating the cycle, electrodes on the semiconductor chip are connected to respective pads on the wiring board 22. Each time the bonding wire is bonded to one of the electrodes on the semiconductor chip 20 or one of the pads on the wiring board 22, ultrasonic vibration is applied to the capillary 16 through the transducer 12 in the bonding head 10, so that ultrasonic waves are applied to contact parts of the bonding wire and a bonding element to which the bonding wire is bonded.

To improve the bondability of the bonding wire with the bonding element, the wire bonding operation may be performed while heating the wiring board 22 and the semiconductor chip 20. Conventionally, the wiring board 22, on which the semiconductor chip 20 is mounted, is placed on a heating stage 30. In bonding the bonding wire to the electrode, the bonding wire is melted and bonded to the electrode with ultrasonic bonding. In bonding the bonding wire to a pad, ultrasonic vibration is applied to the bonding wire and the bonding wire is bonded to the pad using a frictional force (frictional heat) between the bonding wire and the pad. Therefore, it is effective to heat the wiring board 22 and the semiconductor chip 20 during wire bonding operations.

The degree of integration of semiconductor chips has been increased and the intervals between the electrodes on the semiconductor chip have been reduced (about 35 μm pitch). Therefore, bonding wires that have become thinner. As a result, the bonding area between the bonding wire and the bonding element (electrode, pad, etc.) has been reduced and issues have occurred in which the bonding strength may not be sufficient in the bonding section in light of the decreased bonding area and thinner bonding wires.

A heating stage 30 has been used along with above-described related method (hereafter, “related” methods and techniques will be referred to as “conventional”) to address the noted issue and to attempt to enhance enhance the bonding strength between bonding wires and bonding elements. In a conventional wire bonding method using the heating stage 30, the bonding elements are heated so that the alloying ratio of the bonding parts increases, which may increase the bonding strength between the bonding wires and bonding elements.

### SUMMARY

According to an aspect of an embodiment, a wire bonding method includes vibrating a capillary of a bonding head, the capillary having a heater attached thereto at a position corresponding to a node of vibration of the capillary generated by the vibration heating the capillary with the heater and performing a wire bonding operation while heating the capillary with the heater.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Embodiments are illustrated by way of example and not limited by the following figures.

FIG. 1 depicts a bonding head according to an example of an embodiment of the present invention;

FIG. 2 depicts a capillary according to an example of an embodiment of the present invention and a graph showing positions of vibration antinodes of the capillary generated when the capillary is caused to vibrate according to an example of an embodiment of the present invention;

FIG. 3 depicts a result of analysis of vibration of the capillary caused by a transducer according to an example of an embodiment of the present invention;

FIG. 4 is a diagram showing the relationship between the positions of vibration nodes of the capillary and the ultrasonic vibration applied thereto according to an example of an embodiment of the present invention;

FIG. 5 is a graph showing the displacement of the transducer according to an example of an embodiment of the present invention; and

FIG. 6 depicts an operation of wire-bonding a semiconductor chip to a wiring board with an ultrasonic head according to the related art.

### DETAILED DESCRIPTION OF EXAMPLES OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

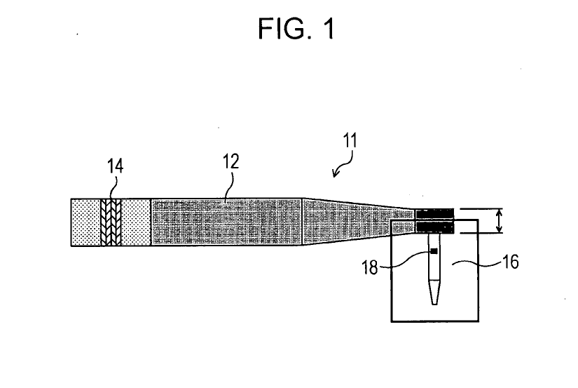

FIG. 1 depicts a wire bonding apparatus that includes a bonding head 11. The bonding head 11 includes a transducer 12, an ultrasonic generator 14 provided at a base portion of the transducer 12, and a capillary 16 fixed to an end portion of the transducer 12.

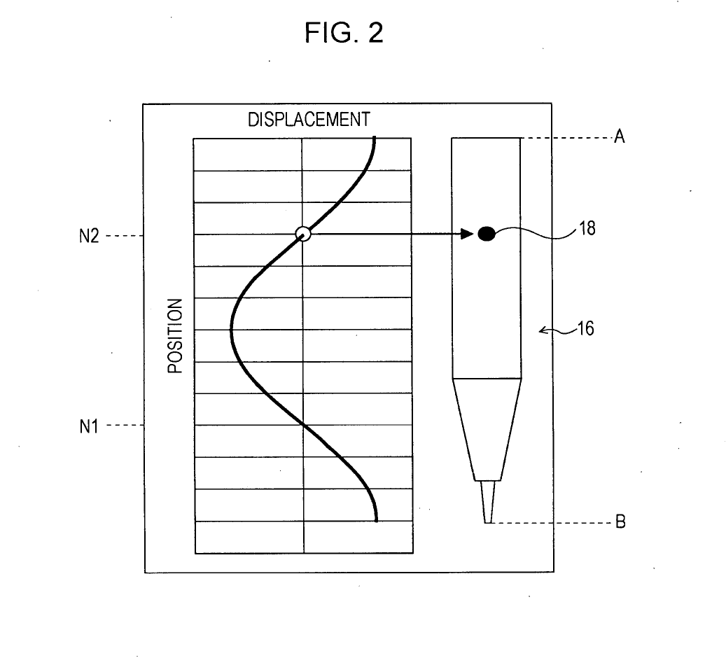

The ultrasonic generator 14 is configured to generate ultrasonic vibration, and the transducer 12 is configured to transmit ultrasonic vibration generated by the ultrasonic generator 14 to the capillary 16. The ultrasonic vibration generated by the ultrasonic generator 14 is transmitted in the form of longitudinal compressional waves along the longitudinal direction of the transducer 12. A piezoelectric element, for example, may be used as the ultrasonic generator 14, and the frequency of the ultrasonic vibration applied to the transducer 12 may be controlled by controlling the frequency of voltage applied to the piezoelectric element. In addition to the transducer 12, the ultrasonic generator 14, and the capillary 16, the bonding head 11 includes a heater 18 for heating the capillary 16. The heater 18 is attached to the capillary 16. The capillary 16 is heated by the heater 18 so that the bondability between the bonding wire and a bonding element to which the bonding wire is to be bonded may be improved. The heater 18 is attached to the capillary 16 at a position corresponding to a node of vibration of the capillary 16 caused by the transducer 12. FIG. 2 shows the displacement of the capillary 16 at each position thereof in the longitudinal direction when the capillary 16 is vibrated in response to the ultrasonic vibration applied thereto. A base end A of the capillary 16 that is fixed to the transducer 12 is forced to vibrate by the transducer 12 in the horizontal direction in FIG. 2. Thus, the base end A of the capillary 16 serves as an antinode of the vibration. A tip end B of the capillary 16 is a point at which the vibration is applied to the bonding wire. Thus, the tip end B also serves as an antinode of the vibration.

FIG. 2 shows an example in which the length of the capillary 16 corresponds to a wavelength of vibration and that the base end A and the tip end B of the capillary 16 both serve as antinodes of the vibration. In this example, two vibration nodes N1 and N2 are provided along the longitudinal direction of the capillary 16 as shown in FIG. 2.

Still referring to FIG. 2, the heater 18 is attached to the capillary 16 at one of the nodes of the forced vibration of the capillary 16. In FIG. 2, the heater 18 is depicted as attached at a position of the node N2, which is the node that is closer to the transducer 12 to which the capillary 16 is fixed. Alternatively, the heater 18 may be attached at the node N1 that is closer to the tip end of the capillary 16. Alternatively, two heaters 18 may be attached at the respective nodes N1 and N2.

The heater 18 is attached at one of the nodes of the forced vibration of the capillary 16 so as to reduce and/or prevent attenuation, by the heater 18, of the ultrasonic vibration applied to the capillary 16 during the ultrasonic bonding operation. Since the nodes of vibration of the capillary 16 serve as fixed points, the operation of bonding the bonding wire using ultrasonic vibration is barely affected when the heater 18 is attached at positions corresponding to the nodes.

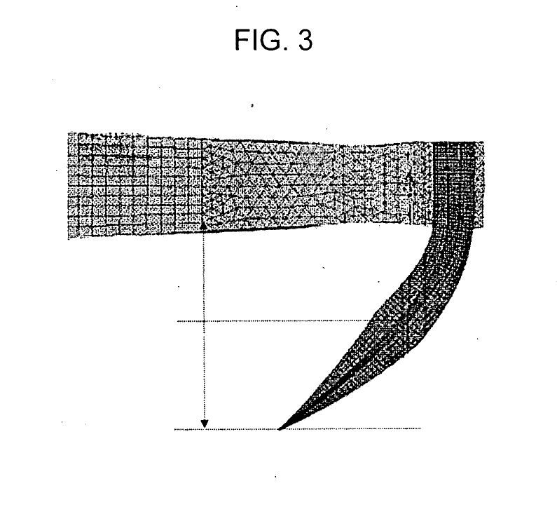

FIG. 3 depicts a result of analysis of vibration of the capillary 16 caused when the transducer 12 to which the capillary 16 is attached is vibrated. The analysis result in FIG. 3 depicts that a portion of the capillary 16 that is connected to the transducer 12 and the tip end of the capillary 16 both serve as at antinodes of the vibration and a single node is provided at the center of the capillary 16 in the longitudinal direction.

In FIG. 3, the amount of displacement of the capillary 16 is strongly emphasized. The amplitude of vibration of the capillary 16 caused by the transducer 12 in the bonding head 11 is about 1 μ, and the length of the capillary 16 is about 5 mm to about 10 mm. Thus, the ratio of the amplitude to the length of the capillary 16 is extremely smaller than that shown in FIG. 3.

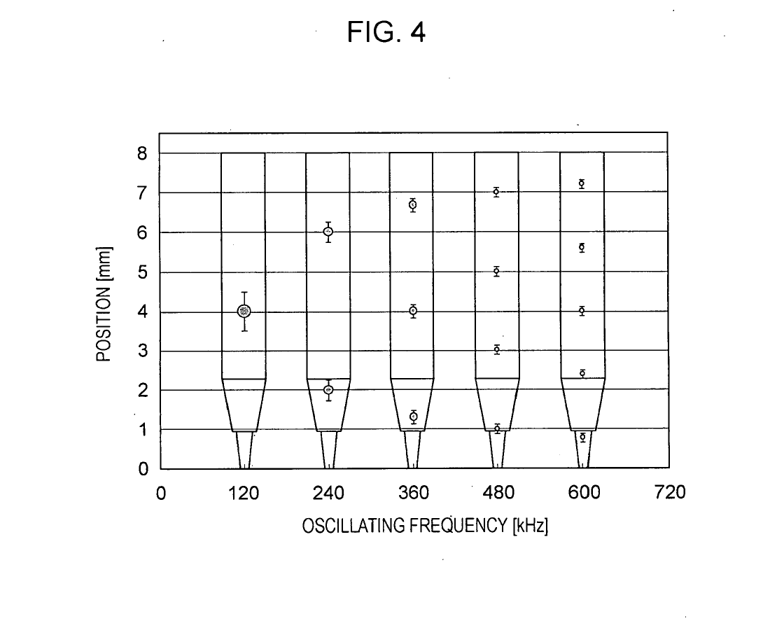

FIG. 4 shows the positions of the nodes of vibration of the capillary 16 when the ultrasonic vibration is applied to the capillary 16 through the transducer 12 of the bonding head 11 at different frequencies. In FIG. 4, the length of the capillary 16 is about 8 mm, and the frequency applied to the capillary 16, in other words, the frequency of the bonding head 11, is set to about 120 kHz, about 240 kHz, about 360 kHz, about 480 kHz, and about 600 kHz.

Among the frequencies of ultrasonic vibration applied to the bonding head 11, 120 kHz is a frequency that is often used. When the frequency is 120 kHz, the capillary 16 has a single node of vibration, as in the state shown in FIG. 3, at the center of the capillary 16 in the longitudinal direction thereof (a position that is about 4 mm away from the tip end). In FIG. 4, small circles show the positions of the nodes of vibration. In comparison, when the frequency of the bonding head 11 is 240 kHz, two nodes are obtained. When the frequency of the bonding head 11 is 360 kHz, three nodes are obtained.

Thus, when the frequency of the bonding head 11 is set to a value obtained by multiplying 120 kHz (referred to herein as a “fundamental frequency”) by a factor of N, N nodes of vibration is provided on the capillary 16. As the frequency increases, the number of nodes of vibration also increases.

When the oscillating frequency of the bonding head 11 is set to 120×N (kHz), where N is a natural number, nodes of vibration of the capillary 16 are provided at positions corresponding to distances calculated as (n/2N)×L, where n is an odd number equal to or less than 2N, and L is the length of the capillary, from the tip end of the capillary 16.

When the frequency of the bonding head 11 is 120 kHz, only one node of vibration may be provided. If only one node is provided, the heater 18 is attached to the position of the single node. In comparison, if the frequency of the bonding head 11 is 120×N (kHz), where N is a natural number of 2 or more, a plurality of nodes are provided. Therefore, the position at which the heater 18 is attached may be selected from the positions of the nodes.

If the heater 18 is attached to the capillary 16 at a position near the tip end thereof, heating efficiency may be increased in the operation of heating the bonding element. However, the tip end of the capillary 16 may have a small diameter so that the bonding wire can be pressed by the tip end of the capillary 16. Accordingly, another consideration for the position at which the heater 18 is to be attached is the strength of the capillary 16 and easiness in attaching the heater 18. In the process of attaching the heater 18 to the capillary 16, the heater 18 is accurately positioned at the node so that the heater 18 does not attenuate the vibration of the capillary 16. However, since the capillary 16 is small, there is a risk that the heater 18 may be attached to the capillary 16 at a position displaced from the intended position. In addition, the heater 18 may be somewhat large and thus, the size of the heater may be considered during placement of the heater at the position on the node of vibration.

If the displacement of the heater 18 is within ±10% of the maximum amplitude of the capillary 16, it may be considered that the vibration of the capillary 16 is not largely attenuated. This condition may be satisfied by attaching the heater 18 within a range of (2 L/N)×0.032 from the position of the node on the capillary 16.

In FIG. 4, the ranges in which the displacement from each node of vibration satisfies the above condition in the process of attaching the heater 18 to the capillary 16 are shown by thin lines. As the frequency of the bonding head increases, the range in which the displacement from the node is allowed becomes narrower. In other words, the accuracy of placement of the heater increases as the frequency of the bonding head.

The frequencies of ultrasonic vibration applied to the bonding head 11 may have the fundamental frequency at 120 kHz, which is a frequency that is generally used in a conventional wire bonding apparatus. However, in an example of an embodiment of the wire bonding apparatus according to the present invention, the frequency applied to the bonding head 11 may be set to a frequency different from 120 (kHz). In such a case, that frequency is set as the fundamental frequency, and the positions of the nodes of vibration of the capillary 16 are determined on the basis of the fundamental frequency. Then, the position at which the heater 18 is to be attached may be determined. The frequency of the ultrasonic vibration applied to the bonding head 11 is not limited to the examples described above and/or shown in FIG. 4.

The diameter of the bonding wire that extends through the capillary 16 is about several tens of micrometers. The outer diameter of the capillary 16 is about 1 mm. Therefore, the size of the heater 18 attached to the capillary 16 is also small. With regard to the method for attaching the heater 18 to the capillary 16, the heater 18 may be adhered to the outer surface of the capillary 16. Alternatively, a heater wire may be wound around the outer peripheral surface of the capillary 16, or a heater element may be inserted through a hole formed in the capillary 16.

The capillary 16 is generally made of a ceramic material. Electricity is supplied to the heater 18, so that the bonding wire is supplied while the capillary 16 is being heated. The heating temperature of the heating stage is about 170° C. to 180° C. As compared to conventional methods and apparatuses in which the heating stage is heated to about 200° C., there is a significantly reduced risk that the wiring board is excessively heated and damaged by the capillary 16.

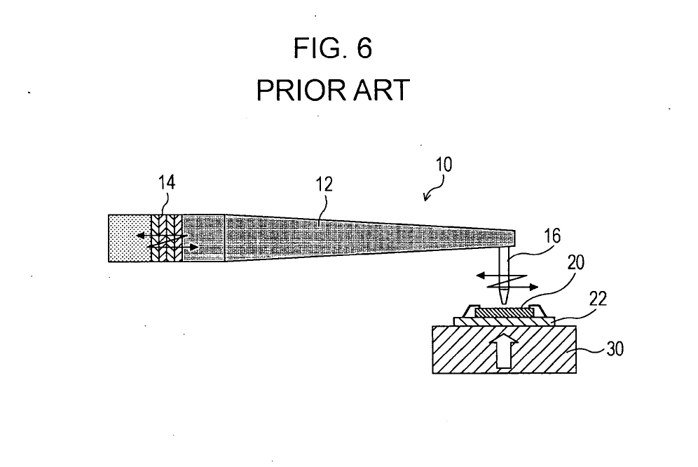

When the wire bonding operation is performed while the capillary 16 is being heated by the heater 18 attached to the capillary 16, in addition to heating the bonding element by setting the workpiece on the heating stage 30 as shown in FIG. 6, the bonding wire may also be heated during the wire bonding operation. Therefore, the contact parts between the bonding wire and the bonding element may be effectively heated and the bonding strength of the bonding wire may be increased.

Accordingly, even if the electrodes are densely arranged on the semiconductor chip and a thin bonding wire is used, the bondability between the bonding wire and the bonding element may be increased and reliability of the electrical connection provided by wire bonding may be improved.

In the above-described example of an embodiment of the present invention, a method for attaching the heater 18 to the capillary 16 of the bonding head 11 is explained. In addition to attaching the heater 18 to the capillary 16 to heat the capillary 16 as described above, an additional heater may be attached to the transducer 12 of the bonding head 11 to heat the transducer 12. Accordingly, the heating efficiency of the bonding wire may be improved and the bondability of the bonding wire may be further improved.

As described above, the transducer 12 transmits the ultrasonic vibration generated by the ultrasonic generator 14 to the capillary 16 as compressional waves. Therefore, when the ultrasonic vibration is applied to the transducer 12, the transducer 12 itself vibrates. As a result, antinodes and nodes of vibration are provided on the transducer 12.

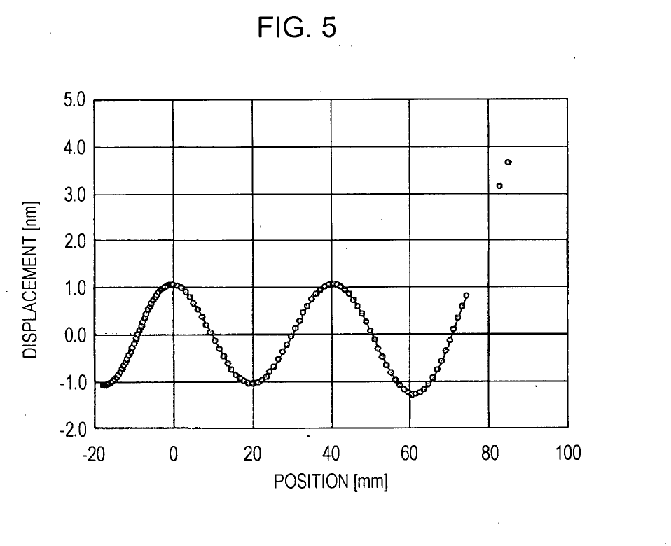

FIG. 5 shows the displacement (displacement of the longitudinal wave) of the transducer 12. In FIG. 5, the positions of nodes correspond to the positions where the displacement is 0. If the heater is attached to the transducer 12 at any of the positions corresponding to the nodes of vibration, the transducer 12 may be heated without substantially attenuating the ultrasonic vibration transmitted through the transducer 12.

In the case where the heater is attached to the transducer 12, the heater may be attached at one of the nodes that is near the position where the capillary 16 is connected to the transducer 12, so that the capillary 16 may be effectively heated. Alternatively, a plurality of heaters may be attached at the respective nodes. When the transducer 12 is heated by the heater or heaters attached thereto, the capillary 16 may be more efficiently heated and the bonding strength between the bonding wire and the bonding element may be further increased.

The capillary may be heated without substantially attenuating the ultrasonic vibration applied to the capillary, and the bonding strength between the bonding wire and the bonding element may be increased by heating the bonding wire in the wire bonding operation. As a result, the reliability of connection between the bonding parts may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A wire bonding apparatus comprising:
an ultrasonic generator to generate ultrasonic vibration;
a transducer to transmit the ultrasonic vibration;
a capillary attached to the transducer to receive the ultrasonic vibration and to vibrate accordingly; and
at least one heater attached to the capillary at a position corresponding to a node of the vibration of the capillary.

2. The wire bonding apparatus according to claim 1, wherein the capillary has a plurality of nodes of vibration, and the at least one heater is positioned at one of the nodes near an end of the capillary.

3. The wire bonding apparatus according to claim 1, wherein the capillary has a plurality of nodes and the at least one heater is a plurality of heaters, the plurality of heaters being positioned at the plurality of nodes.

4. The wire bonding apparatus according to claim 1, wherein the heater is attached in an area within a distance calculated as (2 L/N)×0.032 from the node, where L is a length of the capillary and N is an integer other than 0.

5. The wire bonding apparatus according to claim 1, wherein the transducer has another heater attached thereto at a position corresponding to a node of vibration of the transducer generated by the ultrasonic vibration.

6. A capillary mounted on a transducer for wire bonding, the transducer being configured to transmit ultrasonic vibration, the capillary comprising:
at least one heater disposed at a position corresponding to a node of vibration of the capillary generated by the ultrasonic vibration.

7. The capillary according to claim 6, wherein the capillary has a plurality of nodes of vibration, and the at least one heater is positioned at one of the nodes that is near an end of the capillary.

8. The capillary according to claim 6, wherein the capillary has a plurality of nodes and the at least one heater is a plurality of heaters, the plurality of heaters being positioned at the plurality of nodes.

9. The capillary according to claim 6, wherein the heater is attached in an area within a distance calculated as (2 L/N)×0.032 from the node, where L is a length of the capillary and N is an integer other than 0.
